(19) United States
(12) Patent Application Publication
(10) Pub. No.: US 2026/0278608 A1
(43) Pub. Date: Sep. 17, 2026

(54) BIOMETRIC-BASED TRANSACTION AUTHORIZATION AND FRAUD PREVENTION

(71) Applicants: American Express Travel Related Services Company, Inc., New York, NY (US); AMEX Canada, Inc., North York (CA); American Express Services Europe Limited, London (GB)

(72) Inventors: Magdalena McGoldrick, East York (CA); Manik Biswas, Burgess Hill (GB); Margaret H. Ryan, Jersey City, NJ (US)

(21) Appl. No.: 19/078,430

(22) Filed: Mar. 13, 2025

(51) Int. Cl. G06Q 20/40; G06Q 20/32; G06Q 20/36

(52) U.S. Cl. CPC G06Q 20/40145; G06Q 20/325; G06Q 20/3674; G06Q 20/4016

(57) ABSTRACT

Disclosed are various embodiments for minimizing transaction fraud risks by using biometric data to confirm an identity of a user engaging in a transaction. In various examples, biometric data (e.g., fingerprint, retina scan, iris scan, handprint, voice sample, face scan, user gesture, etc.) can be captured at the time of a transaction and transmitted to the issuer when requesting a transaction authorization. The issuer can analyze the biometric data during the risk decisioning process for authorizing a transaction. For example, the biometric data captured at the time of the transaction can be compared with stored biometric data associated with the user of the user account. If the biometric data fails to match the stored biometric data, the authorization may be denied.

### BACKGROUND

Mobile wallet payment fraud continues to grow, with fraud attacks becoming increasingly more sophisticated. While issuers can leverage several data inputs to make authorization decisions, confirming a user's identity at the time of payment can be difficult. For example, while the card or device may be present at the time of transaction, that doesn't necessarily mean the cardholder is making the transaction. Even with biometric authentication, device enabled payments are subject to compromise by fraudulent and/or bad actors. For example, devices can be stolen and biometrics credentials can be swapped, which can allow for a thief to make multiple fraudulent transactions until some remedial action is performed.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIGS. 2A and 2B are drawings of example network environments according to various embodiments of the present disclosure.

FIG. 3 is a sequence diagram illustrating examples of functionality in the network environments of FIGS. 2A and 2B according to various embodiments of the present disclosure.

FIG. 4 is a sequence diagram illustrating examples of functionality in the network environments of FIGS. 2A and 2B according to various embodiments of the present disclosure.

FIG. 5 is a sequence diagram illustrating examples of functionality in the network environments of FIGS. 2A and 2B according to various embodiments of the present disclosure.

FIG. 6 is a flowchart illustrating one example of functionality implemented as portions of an application executed in a computing environment in the network environments of FIGS. 2A and 2B according to various embodiments of the present disclosure.

FIG. 7 is a flowchart illustrating one example of functionality implemented as portions of an application executed in a computing environment in the network environment of FIG. 2B according to various embodiments of the present disclosure.

### DETAILED DESCRIPTION

Disclosed are various approaches for minimizing transaction fraud risks by using biometric data to confirm an identity of a user engaging in a transaction. In various examples, biometric data (e.g., fingerprint, retina scan, iris scan, handprint, voice sample, face scan, user gesture, etc.) can be captured at the time of a transaction and transmitted to the issuer when requesting a transaction authorization. The issuer can analyze the biometric data during a risk decisioning process for authorizing a transaction to help combat against fraud and bad actors. For example, the biometric data captured at the time of the transaction can be compared with stored biometric data associated with the user of the user account. In some examples, a need for additional security measures can be predicted according to one or more fraud prediction factors (e.g., location, user input, cost of transaction, merchant, terminal type, etc.). In these situations, a wallet can be pre-armed with verification data that is based at least in part on a biometric verification that occurs prior to the transaction. In addition, the predicted need for additional security measures can be used as a factor on during the risk decisioning process for authorizing a transaction.

In various examples, an issuer of a credential (e.g., payment, access, etc. can store biometric data associated with a user of a user account. The biometric data can include user gesture data (e.g., gait, how a user holds a phone, etc.), facial features (e.g., a photo of the user's face, a video of the user's face, etc.) voice features, fingerprint data, iris scan, retina scan, handprint, and/or other type of biometric data. For example, during the registration process for obtaining a credential issued by the issuer, a user can provide biometric data to the issuer that is stored for use in future verification tasks. In some examples, the issuer can update or otherwise collect the biometric data following the issuance of the given credential and/or establishment of a user account.

In various examples, when a user establishes a direct wireless connection with a terminal (e.g., payment terminal, access terminal, etc.) via a user device (e.g., mobile device, etc.) for a pending transaction, biometric data can be captured via a biometric capturing device of the user device and/or the terminal. When the terminal sends an authorization request to the issuer to authorize the transaction, the authorization request can contain the captured biometric data. In turn, the issuer can include the biometric data in the risk decision analysis as a factor in determining whether to authorize the transaction. For example, part of the risk decision analysis can include comparing the biometric data included in the authorization request with stored biometric data. If there is a match, the identity of the user can be verified according to the match. Accordingly, the transaction can be authorized based at least in part on the verification of the user's identity. If there is not a match or the risk decision analysis of the issuer requires additional biometric data from the user, the issuer can request additional biometric data prior to authorizing the transaction. Accordingly, the issuer can notify the terminal that additional biometric data is required to authorize the transaction. The terminal can capture the additional biometric data and/or request that the device capture and transmit the additional biometric data to the terminal. Accordingly, the terminal can transmit the additional biometric data to the issuer for further analysis and verification.

In some examples, a need for additional security can be predicted by the issuer or user associated with a user account provided by the issuer. For example, an issuer can monitor various fraud prediction factors including device location, a change in spend pattern, a user input, user behavior, a user gesture, a change in device language, and/or other type of factor. In various examples, the fraud predication factors can be applied to a trained fraud prediction model that can indicate a degree or level of fraud risk for a transaction.

In response to monitoring the fraud prediction factors, the issuer may determine that the level or degree of fraud risk for the transaction meets or exceeds a threshold and prompt the user to provide proof of his or her presence alongside the device. In this example, a user device can capture biometric data associated with the user. In some examples, the biometric data is sent to the issuer who in turn compares the captured biometric data with stored biometric data to verify the presence of the user with the device. In various examples, the issuer can generate and provide a verification token to the user device that can be used when by the user device for transactions. In some examples, the user device can compare the captured biometric data with stored biometric data and generate a verification token in response to the captured biometric data matching the stored biometric data.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

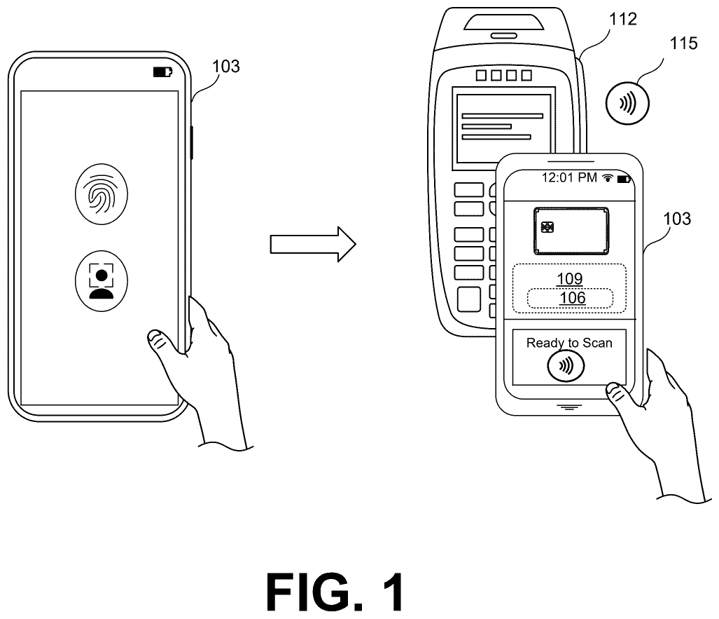

As illustrated in FIG. 1, shown is an example scenario 100 in which a client device 103 captures biometric data 106 associated with a user interacting with the client device 103 and includes the biometric data 106 in a transaction payload 109 that is transferred to a terminal 112 via a direct wireless connection 115. In particular, the example scenario 100 of FIG. 1 relates a client device 103 tapping or otherwise being placed in an appropriate proximity to a terminal 112 to establish a direct wireless connection 115 (e.g., near-field communication (NFC), Bluetooth, ultrawideband (UWB) communication, etc.) for the transaction that requires authentication. In various examples, the transaction payload 109 that is transferred to the terminal 112 from the client device 103 can include captured biometric data 106.

In various examples, the client device 103 can capture biometric data 106 associated with the user interacting with the client device 103. The biometric data 106 can include user gesture data (e.g., gait, how a user holds a phone, etc.), facial features (e.g., a photo of the user's face, a video of the user's face, etc.), voice features, fingerprint data, iris scan, retina scan, handprint, and/or other types of biometric data. In some examples, the biometric data is captured passively without user input. In other examples, the client device 103 prompts the user to provide the biometric data 106 via one or more user interactions.

In various examples, the client device 103 can generate a transaction payload 109 that includes transaction data associated with the transaction and the captured biometric data 106. The transaction data can include credential data (e.g., credential identifier, verification code, expiration date, issuer identifier, billing address, credential name, etc.), merchant information, transaction amount, terminal identifier, and/or other information that may be required for the transaction. In some examples, the transaction payload 109 can be in the form of a cryptogram.

Although not illustrated in the example of FIG. 1, once the terminal 112 receives the transaction payload 109, the terminal 112 can generate an authorization request to send to the issuer associated with the credential of the transaction. The authorization request can include the captured biometric data 106 along with transaction data associated with the transaction. It should be noted that although the captured biometric data 106 of FIG. 1 is based on biometric data 106 captured by the client device 103, in some examples, the terminal 112 can capture biometric data 106 associated with the user of the client device 103. The terminal 112 can transmit the authorization request to the issuer.

In various examples, the issuer can authorize the transaction based at least in part on a risk decision analysis. As part of the risk decision analysis, the issuer can compare the biometric data 106 included in the authorization request with stored biometric data. If there is a match, the identity of the user can be verified according to the match. Accordingly, the transaction can be authorized based at least in part on the verification of the user's identity. If there is not a match or the risk decision analysis of the issuer requires additional biometric data 106 from the user, the issuer can request additional biometric data prior to authorizing the transaction. Accordingly, the issuer can notify the terminal 112 that additional biometric data 106 is required to authorize the transaction. The terminal 112 can capture the additional biometric data and/or request that the client device 103 capture and transmit the additional biometric data 106 to the terminal 112. Accordingly, the terminal 112 can transmit the additional biometric data 106 to the issuer for further analysis and verification.

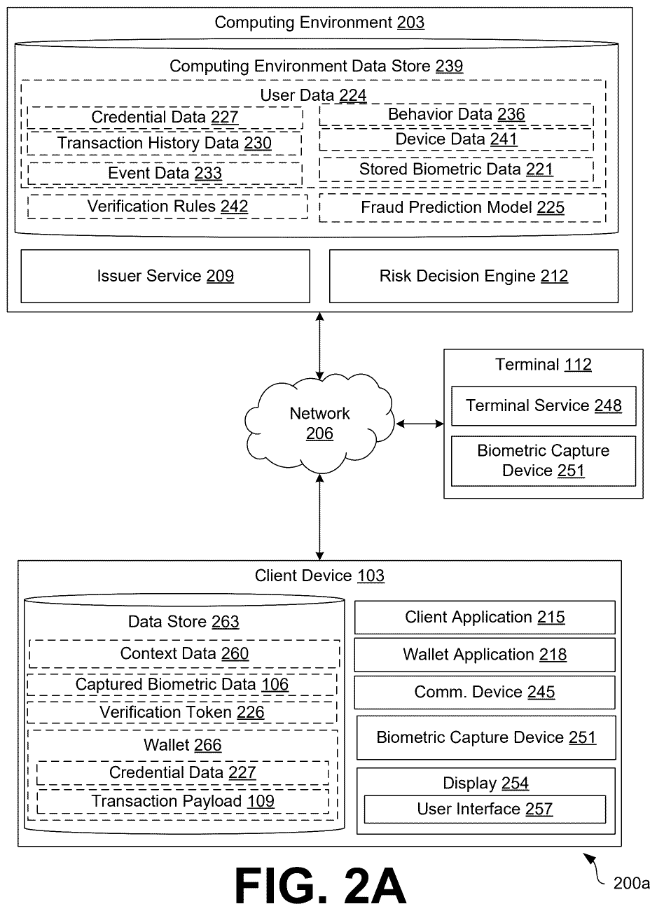

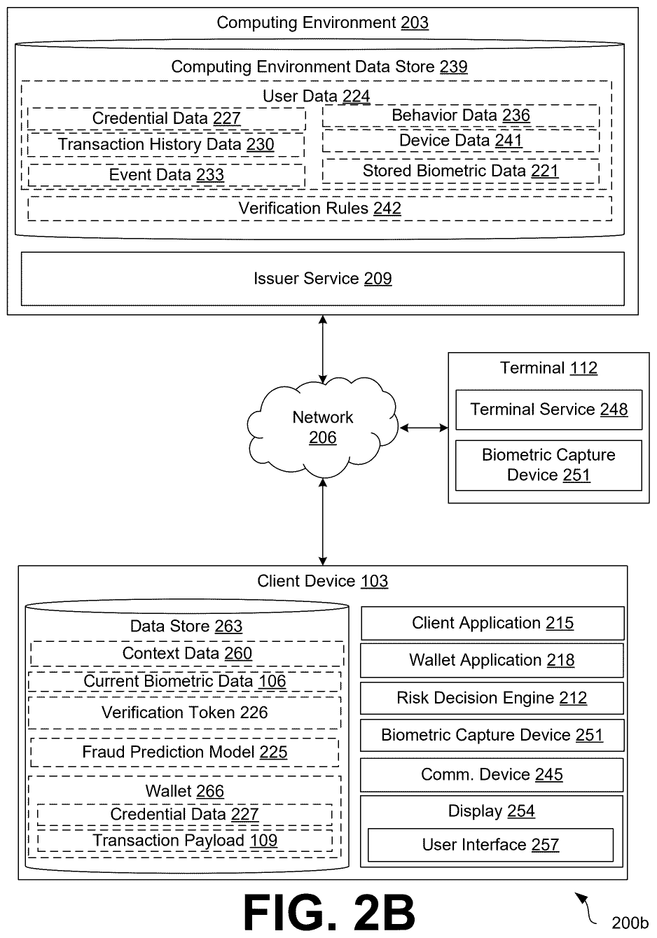

With reference to FIGS. 2A and 2B, shown are example network environments 200 (e.g., 200a, 200b) according to various embodiments. The network environment 200 can include a computing environment 203, a client device 103, and a terminal 112, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 of FIG. 2A include an issuer service 209, a risk decision engine 212, and other applications, services, processes, systems, engines, or functionality not discussed in detail herein. FIG. 2A differs from FIG. 2B in that the risk decision engine 212 is included within and executed by the computing environment 203 whereas in FIG. 2B, the risk decision engine 212 is included within and executed by the client device 103.

The issuer service 209 can interact with a client application 215 and/or a wallet application 218 on a client device 103 to provide backend functionality for the client application 215 and/or the wallet application 218. For example, the issuer service 209 can interact with the client application 215 and/or the wallet application 218 to provide security services (e.g., authorization and authentication services needed by the client application 215 and/or the wallet application 218 to perform various tasks), provide data synchronization across multiple devices and platforms, and/or other operations.

In various examples, the issuer service 209 can interact with the client application 215 and/or the wallet application 218 to register or otherwise onboard a user when issuing the user a user account associated with a given credential (e.g., payment, access, identity, etc.). During the registration and/or onboarding process, the issuer service 209 can obtain stored biometric data 221 associated with the user of the registered and/or onboarded account. The stored biometric data 221 can include user gesture data (e.g., gait, how a user holds a phone, etc.), facial features (e.g., a photo of the user's face, a video of the user's face, etc.), voice features, fingerprint data, iris scan, retina scan, handprint, and/or other type of biometric data. In various examples, the issuer service 209 can use the stored biometric data 221 for future verification of the identify of a user.

In some examples, the issuer service 209 can monitor fraud prediction factors associated with a given client device 103 and/or user account to determine whether an additional need for security is required for future or pending transactions. For example, the issuer service 209 can monitor fraud predication factors including device location, a change in spend pattern, a user input, user behavior, a user gesture, a change in device language, user data 224 and/or other type of factors. In various examples, the fraud predication factors can be applied to a trained fraud prediction model 225 that can indicate a level of fraud risk. In other examples, weights can be applied to the fraud prediction factors and a sum of the weights can be calculated and compared to a given threshold value to determine a likelihood of a need of increased security.

When the issuer service 209 determines a level of fraud risk, the issuer service 209 can request the client application 215 and/or the wallet application 218 to prompt the user for biometric data. The client device 103 can then capture biometric data 106 of the user interacting with the client device 103 and send the captured biometric data 106 to the issuer service 209. The issuer service 209 can then compare the captured biometric data with the stored biometric data 221 to determine a match. If the captured biometric data 106 matches the stored biometric data 221, the issuer service 209 can generate a verification token 226 that verifies the identity of the user. In various examples, the verification token 226 can be generated to include an expiration date such that the verification token 226 is valid for a predetermined amount of time. When engaging in a transaction, the wallet application 218 can generate the transaction payload 109 to include the verification token 226 for additional security and verification.

In some examples, the issuer service 209 can be executed to provision terminals 112 to accept payments using credentials issued by the issuer. The issuer service 209 can receive pending transaction data with an authorization request for a given transaction from the terminal 112. In various examples, the authorization request can include captured biometric data 106 that includes biometric data that is captured at the time of or within a predefined period of time within the occurrence of a transaction between a client device 103 and the terminal 112.

The issuer service 209 can analyze the pending transaction data along with the captured biometric data 106 during a risk decision process to determine whether to authorize or deny the transaction. In particular, the issuer service 209 can analyze a variety of transaction authorization factors including the transaction data, the captured biometric data 106, user data 224, and/or other data to determine a risk associated with approving the transaction. In some examples, the issuer service 209 can assign weights to each of the transaction authorization factors. In this example, a score can be calculated based at least in part on a sum of the assigned weights and the issuer service 209 can authorize or deny the transaction based at least in part on whether the score meets or exceeds a predefined threshold value.

For example, using the pending transaction data included in an authorization request, the issuer service 209 can confirm that funds or credit is available for a given payment credential, such that the payment transaction is authorized to proceed or not authorized to proceed. In another example, the issuer service 209 can compare the captured biometric data 106 with the stored biometric data 221. If there is a match, the identity of the user can be verified according to the match. Accordingly, the issuer service 209 can authorize the transaction based at least in part on the verification of the user's identity.

If there fails to be a match or the risk decision analysis of the issuer service 209 determines that additional captured biometric data 106 is needed from the user, the issuer service 209 can request additional captured biometric data 106 prior to authorizing the transaction. Accordingly, the issuer service 209 can notify the terminal 112 that additional biometric data is required to authorize the transaction. The terminal 112 can capture the additional biometric data and/or request that the client device 103 capture and transmit the additional captured biometric data 106 to the terminal 112. Accordingly, the terminal 112 can transmit the additional captured biometric data 106 to the issuer service 209 for further analysis and verification.

In some examples, the issuer service 209 can execute the risk decision engine 212 to determine whether or not to authorize a given transaction. For example, the risk decision engine 212 can be executed to analyze one or more transaction authorization factors in determining whether to authorize or deny a transaction. The one or more transaction authorization factors can include, for example, the transaction data (e.g., transaction amount, merchant, transaction type, etc.), the captured biometric data 106, user data 224 (e.g., credential data 227, transaction history data 230, event data 233, behavior data 236, location data, date/time, etc.), and/or other data to determine a risk associated with approving the transaction. In some examples, the risk decision engine 212 can assign weights to each of the transaction authorization factors. In this example, a score can be calculated based at least in part on a sum of the assigned weights and the transaction can be authorized or denied based at least in part on a comparison of the score with a predefined threshold value. In other examples, the risk decision engine 212 can comprise a trained model that is trained to output a risk associated with the authorization of the pending transaction.

In various examples, the issuer service 209 can determine whether to authorize or deny the transaction based at least in part on the output of the trained model. In some examples, the output can include a score that indicates the likelihood of risk associated with the transaction. Based on the output of the risk decision engine, the issuer service 209 can determine that additional captured biometric data 106 is needed from the user. Accordingly, the issuer service 209 can request additional captured biometric data 106 prior to authorizing the transaction. In this example, the issuer service 209 can notify the terminal 112 and/or the client device 103 that additional biometric data 106 is required to authorize the transaction. The terminal 112 can capture the additional biometric data 106 and/or request that the client device 103 capture and transmit the additional captured biometric data 106 to the terminal 112. Accordingly, the terminal 112 and/or the client device 103 can transmit the additional captured biometric data 106 to the issuer service 209 for further analysis and verification.

Also, various data is stored in a data store 239 that is accessible to the computing environment 203. The data store 239 can be representative of a plurality of data stores 239, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 239 is associated with the operation of the various applications or functional entities described below. This data can include user data 224, verification rules 242, a fraud prediction model 225, and potentially other data.

The user data 224 can represent data related to users having accounts with the organization or enterprise associated with the computing environment 203. For example, the user data 224 can correspond to information related to individuals who have been issued payment accounts by an issuer associated with the issuer system. A payment account can represent any financial account or agreement that a customer can use as a source of funds for payments. Payment accounts can include both credit accounts or facilities and financial deposit accounts that provide the owner with on demand access to funds stored in or associated with the payment account. In some instances, a payment account can allow a user to have frequent and/or immediate access to funds. In these instances, payment accounts can also be referred to as demand deposit accounts, which can be accessed in a variety of ways, such as the use of debit cards, checks, or electronic transfers (e.g., wire transfer, automated clearing house (ACH) transfer, real-time payment (RTP) networks such as FedNow or The Clearinghouse (TCH), etc.). Examples of payment accounts include charge or charge card accounts, credit or credit card accounts, checking accounts, savings accounts, money market accounts, demand accounts, deposit accounts, demand deposit accounts, etc.

The user data 224 can include credential data 227, transaction history data 230, event data 233, behavior data 236, device data 241, stored biometric data 221, and/or other data associated with the user.

The credential data 227 can include data associated with credentials issued to the user. For example, the credential data 227 can comprise data identifying payment credentials, identification credentials, access credentials, loyalty account credentials, and/or other type of data associated with a credential of a user. For example, a payment credential can comprise data describing credit cards, debit cards, virtual cards, charge cards, and/or other mechanisms for effecting a payment with respect to a transaction account provided by the issuer and associated with the user of the client device 103. For example, for a credit card or a charge card, the payment credential can store a card number, a cardholder name, an expiration date, a verification code, a billing address, and/or other information needed to consummate a payment. An identification credential can be used to verify personal information about a user such as, for example, a username, date of birth, address, photograph, identification number, biometric data, physical characteristics, and/or other type of personal information. An access credential can be used to grant the user access to a specific location. The access credential can comprise user information, access level, credential type, issuing authority, expiration data, and/or other types of information.

The transaction history data 230 includes transaction data associated with prior transactions associated with any one of the user credentials represented by the credential data 227. In the example of a payment transaction, the transaction history data 230 can include a transaction amount, a transaction merchant, industry identification data associated with the transaction, transaction time, transaction date, transaction authentication mode, transaction mode, transaction location information, network connectivity data, device data, user account data, and/or other attributes associated with a given transaction.

The event data 233 can represent data corresponding to events associated with the user. For example, the event data 233 can include calendar data, ticket data, registration data, and/or other type of information associated with an event. The event data 233 can include a type of event, a date of the event, a location of the event, and/or other type of event information.

The behavior data 236 can represent data associated with the user's behavior. For example, the behavior data 236 can include digital interactions (e.g., page views, scrolling behavior, search queries, digital purchase behavior, etc.), routine physical behaviors (e.g., where a user routinely visits), transaction behaviors (e.g., what payment card a user uses at a given store, transaction terminal mode (e.g., tap, insert, swipe, user wallet, etc.), loyalty engagement data, and/or other type of data that can define a user's actions in a given situation.

The device data 241 can include information about the end user client device 103. The device data 241 can include, for example, information specifying applications that are installed on the client device 103, configurations or settings that are applied to the client device 103, user accounts associated with the device 103, the physical location of the client device 103, and/or other information associated with the client device 103.

The stored biometric data 221 can include user gesture data (e.g., gait, how a user holds a phone, etc.), facial features (e.g., a photo of the user's face, a video of the user's face, etc.) voice features, fingerprint data, iris scan, retina scan, handprint, and/or other type of biometric data associated with a user of a user account. In some examples, the stored biometric data 221 can be captured and stored during the registration process for obtaining a credential issued by the issuer. In some examples, the stored biometric data 221 can be updated or otherwise collected following the issuance of the given credential and/or establishment of a user account.

The verification rules 242 can include rules, models, and/or configuration data for the various algorithms or approaches employed by the issuer service 209 for verification of a user identity. For example, the verification rules 242 can include rules or algorithms that can be used by the issuer service 209 to compare the stored biometric data 221 with captured biometric data 106 in determining a match. In some examples, the verification rules 242 can define when additional biometric data 221 may need to be captured for authorization for a transaction. For example, if a risk score that is determined by a risk decision analysis is within a predefined threshold range defined by the verification rules 242, the issuer service 209 can determine that additional biometric data 221 is required. In some examples, the verification rules 242 can indicate that if a predicted likelihood of fraud is determined to be within a predefined threshold defined by the verification rules 242, the issuer service 209 can determine that additional biometric data 221 is required. In some examples, the verification rules 242 can indicate what type of biometric data 221 is required for verification of a user's identity.

The fraud prediction model 225 can include, for example, a logistic regression classifier, a random forest classifier, a decision tree classifier, a XGBoost classifier, a multi-layer perceptron classifier, a recurrent neural network, a feed-forward neural network, a label-specific attention network, and/or any other type of trained model as can be appreciated. According to various examples, the fraud predication model 225 can be trained historical data to analyze input data (e.g., user data 224, device location, a change in spend pattern, a user input, user behavior 236, a user gesture, a change in device language, and/or other type of factor, etc.) to make an informed prediction of potential fraud with any future transactions.

The terminal 112 can represent a transaction system that can include a corresponding computer system or computing device with a processor and a memory. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a payment terminal, an access terminal, a point of sale (PoS) system, or other devices with like capability.

In various examples, the terminal 112 can accept direct wireless communications (e.g., NFC, Bluetooth, UWB, etc.) for communicating with a client device 103. For example, when a user is wanting to complete a transaction, the user could tap or otherwise place the client device 103 and/or communication device 245 of the client device 103 in an appropriate proximity to the terminal 112 to establish a direct wireless connection 115 with the terminal 112. Upon establishing a direct wireless connection 115, the client device 103 can transmit the transaction payload 109 the terminal 112.

Various applications or other functionality can be executed by the terminal 112 according to various embodiments. The components executed on a transaction terminal 112 can include a terminal service 248, and other applications, services, processes, systems, engines, or functionality not discussed in detail herein.

In various examples, the terminal service 248 can receive the transaction payload 109 comprising the transaction data, captured biometric data 106, verification token 228, and/or other data from a client device 103. In various examples, the terminal service 248 can verify an identity of the user in response to verifying the verification token 228 included in the transaction payload 109. In some examples, the terminal service 248 can extract the captured biometric data 106 from the transaction payload 109. In other examples, the terminal service 248 can request the biometric capture device 251 of the terminal 112 to capture biometric data 106 of the user associated with the client device 103 associated with the direct wireless connection 115.

In various examples, the terminal service 248 can generate an authorization request to send to the issuer service 209 to authorize or deny a given transaction. The authorization request can be generated to include transaction data, the captured biometric data 106, the verification token 228, and/or other data that the issuer service 209 may need to authorize or deny a transaction. In some examples, the terminal service 248 can send the authorization request to the issuer service 209.

In some examples, the terminal service 248 can obtain a response to the authorization request from the issuer service 209. When the response indicates that the transaction has been authorized, the terminal service 248 can proceed with authorizing the transaction. When the response indicates that the transaction has been denied, the terminal service 248 can deny the transaction and, in some examples, notify the user associated with the client device 103 that the transaction has been denied.

In various examples, the response to the authorization request can indicated that additional biometric data 106 is required. When additional biometric data 106 is required, the terminal service 248 can obtain the additional biometric data 106 and send the additional biometric data 106 to the issuer. In some examples, the terminal service 248 obtains the additional biometric data 106 by sending a request to the client device 103 and obtaining the additional biometric data 106 in response to the request. In other examples, the terminal service 248 requests the additional biometric data 106 from a biometric capture device 252 associated with the terminal 112 and in communication with the terminal service 248.

In various examples, the biometric capture device 252 is a device that can be configured to collect biometric data from a user that represents a unique physical characteristic of the user (e.g., fingerprint, retina scan, iris scan, facial scan, handprint, voice sample data, etc.). For example, the biometric capture device 252 can comprise an input sensor module (e.g., fingerprint scanner, voice recorder, iris scanner, retina scanner, camera, etc.) for obtaining biometric data associated with the user.

The client device 103 is representative of a plurality of client devices that can be coupled to the network 206. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 254, such as liquid crystal displays (LCDs), gas plasma-based flat panel displays, organic light emitting diode (OLED) displays, electrophoretic ink (“E-ink”) displays, projectors, or other types of display devices. In some instances, the display 254 can be a component of the client device 103 or can be connected to the client device 103 through a wired or wireless connection.

The client device 103 can be configured to execute various applications such as a client application 215, a wallet application 218, or other applications. The client application 215 can be executed in a client device 103 to access network content served up by the computing environment 203 or other servers, thereby rendering a user interface 257 on the display 254. To this end, the client application 215 can include a browser, a dedicated application, or other executable, and the user interface 257 can include a network page, an application screen, or other user mechanism for obtaining user input. The client device 103 can be configured to execute applications beyond the client application 215 such as email applications, social networking applications, word processors, spreadsheets, or other applications.

The wallet application 218 can be executed to monitor and send context data 260 to the issuer service 209. The context data 260 can comprise transaction data, device data 241, event data 233, location data, and/or other data. The context data 260 can be transmitted periodically, randomly, and/or at scheduled time.

In various examples, the wallet application 218 can be executed to capture biometric data 106 associated with a user of the client device 103. For example, the wallet application 218 can interact with the biometric capture device 251 included within and/or in communication with the client device 103 to request the capture of biometric data 106. In various examples, the captured biometric data 106 can include user gesture data (e.g., gait, how a user holds a phone, etc.), facial features (e.g., a photo of the user's face, a video of the user's face, etc.), voice features, fingerprint data, iris scan, retina scan, handprint, and/or other type of biometric data associated with a user of the client device 103.

In some examples, the wallet application 218 can be executed to interact with the issuer service 209. For example, the wallet application 218 can interact with the issuer service 209 to register or otherwise onboard for a user account and/or credential issued by the issuer associated with the issuer service 209. In other examples, the wallet application 218 can interact with the issuer service 209 in response to the issuer service 209 and/or a user input predicting a need for additional security. In this example, the issuer service 209 can prompt the user via interactions with the wallet application 218 for biometric data 106 that can be captured and used for verification purposes. In some examples, the issuer service 209 can obtain biometric data 106 from the wallet application 218 and generate a verification token 226 verifying the identity of the user when the captured biometric data 106 matches stored biometric data 221. In some examples, the client device 103 includes stored biometric data 221, and the wallet application 218 can generate a verification token 226 in response to comparing captured biometric data 106 with the stored biometric data 221 on the client device 103.

In various examples, the wallet application 218 can receive a request to establish a direct wireless connection 115 with a terminal 112. In some examples, the wallet application 218 can receive the request in response to the user tapping or otherwise placing the client device 103 in an appropriate proximity to the terminal 112 to establish a direct wireless connection 115. In some examples, the user can interact with a user interface 257 associated with the wallet application 218 and request via the interactions to establish the direct wireless connection 115.

In some examples, once the direct wireless connection 115 is established with the terminal 112, the wallet application 218 can receive transaction details associated with the transaction such as, for example, a transaction amount, a terminal identifier, a merchant identifier, and/or other data. In various examples, the wallet application 218 can generate the transaction payload 109 to provide to terminal 112 for the given transaction based at least in part on the transaction details received from the terminal 112. The transaction payload 109 can comprise a payload including transaction data, credential data, the captured biometric data 106, a verification token 226, and/or other data. The wallet application 218 via the communication device 245 can transmit the transaction payload 109 to the terminal 112.

In some examples, the transaction payload 109 can be generated to be compliant with transfer standards of the direct wireless connection 115. For example, if the direct wireless connection 115 is a near-field communication (NFC) connection, the transaction payload 109 can be an ISO7816 compliant and/or other NFC compliant tag that is generated to represent the credential to be transferred for the transaction.

Also, various data is stored in the client data store 263 that is accessible to the client device 103. The client data store 263 can be representative of a plurality of data stores as can be appreciated. The data stored in the client data store 263, for example, is associated with the operation of various applications and/or functional entities described herein. The client data store 263 can store context data 260, captured biometric data 106, a verification token 226, a wallet 266, and other data as can be appreciated.

The context data 260 can include data associate with a user account and context of the user and device 103 at a given time. In various examples, the context data 260 can include transaction data, device data 241, event data 233, location data, and/or other data. The transaction data can include data associated with a transaction. This data can include a date, a time, a location, transaction items, transaction amount, transaction credential, transaction terminal 112, transaction merchant, and/or other data about the transaction. The device data 241 can include information about the end user client device 103. The device data 241 can include, for example, information specifying applications that are installed on the client device 103, configurations or settings that are applied to the client device 103, user accounts associated with the device 103, the physical location of the client device 103, and/or other information associated with the client device 103.

The wallet 266 is associated with the wallet application 218 and corresponds to a digital credential wallet for securely storing credentials and associated credential data 227 of the user. For example, the credential data 227 can comprise data identifying payment credentials, identification credentials, access credentials, loyalty account credentials, and/or other type of data associated with a credential of a user. In addition, the wallet 133 can store one or more transaction payloads 109 associated with a transaction with a terminal 112. The transaction payload 109 can comprise a payload including transaction data, credential data 227, captured biometric data 106, a verification token 226, and/or other data.

In various examples, the client device 103 can include a communication device 245 which can either be integrated within the client device 103 and/or in data communication with the client device 103. The communication device 245 can include a device that uses protocol standards to establish a direct wireless connection 115 with other devices with similar or like capability. For example, the communication device 245 can comprise an NFC device that uses NFC protocols to establish NFC peer-to-peer connections for exchanging data wirelessly via an NFC protocol to another device with similar or like capability. For example, the wallet application 218 can interact with the communication device 245 to transfer the transaction payload 109 to a terminal 112 in response to the communication device 245 establishing a direct wireless connection 115 with the terminal 112.

It should be noted that the network environment 200a of FIG. 2A differs from the network environment 200 b of 2B in that in that the risk decision engine 212 and the fraud prediction model 225 are included within and executed by the computing environment 203 whereas in FIG. 2B, the risk decision engine 212 and the fraud prediction model 225 are included within and executed by the client device 103. For example, in FIG. 2B, the wallet application 218 and/or the client application 215 can collect fraud prediction factors based at least in part on the context data 260 and/or user input and apply the fraud prediction factors as inputs to the fraud prediction model 225. In various examples, upon determining that a likelihood of fraud meets or exceeds a predefined threshold value, the wallet application 218 can prompt the user of the user device 103 to provide biometric data 106 that can be used to verify the identity of the user. In response to verifying the identity of the user by comparing the captured biometric data 106 with stored biometric data 221, the wallet application 218 can generate a verification token 226. In other examples, the wallet application 218 can send a request to the issuer service 209 and/or other verifier service in response to determining that the likelihood of fraud meets or exceeds a predefine threshold. In various examples, the request includes captured biometric data 106 that has been captured within a predefined period of time relative to the determination that there is a need for additional security based at least in part on a likelihood of fraud.

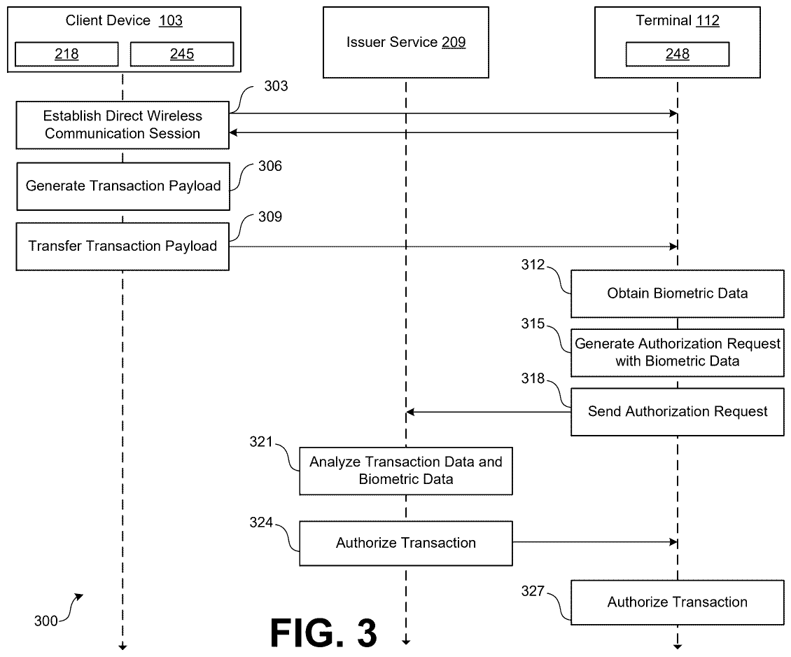

Next, a general description of the operation of the various components of the network environment 200 is provided with respect to FIGS. 3-7. Although the following description provides one illustrative example of the operations of and interactions between the various components of the network environment 200(other operations and interactions are also encompassed by the various embodiments of the present disclosure. More detailed discussion of the operations of individual components is provided in the discussion accompanying the subsequent drawings.

FIG. 3 illustrates a sequence diagram 300 that provides an example of the operation of the components of the network environment 200. It is understood that the sequence diagram 300 of FIG. 3 provides merely an example of the many different types of functional arrangements that can be employed to implement the operation of the depicted portion of the network environment 200. As an alternative, the sequence diagram 300 of FIG. 3 can be viewed as depicting an example of elements of a method implemented within the network environment 200.

To begin, at block 303, the wallet application 218 via the communication device 245 can establish a direct wireless connection 115 with a terminal 112. For example, when a user is wanting to complete a transaction, the user could tap or otherwise place the client device 103 and/or communication device 245 of the client device 103 in an appropriate proximity to the terminal 112 to establish a direct wireless connection 115 with the terminal 112. In some examples, once the direct wireless connection 115 is established with the terminal 112, the wallet application 218 can receive transaction details associated with the transaction such as, for example, a transaction amount, a terminal identifier, a merchant identifier, and/or other data.

At block 306, the wallet application 218 can generate a transaction payload 109 based at least in part on the transaction details and credential data 227 of a given credential. The transaction payload 109 can include a credential identifier, credential data 227, credential security features (e.g., public key), a digital signature, an expiration date, and/or other type of data that would be needed by a receiving terminal 112 to complete a transaction.

In various examples, the wallet application 218 can generate the transaction payload 109 to include captured biometric data 106 which can be used for verification and fraud prevention. In various examples, prior to engaging in a transaction with a terminal 112 or in response to establishing the direct wireless connection 115 with the terminal 112, the wallet application 218 can capture biometric data 106 associated with a user interacting with the client device 103. The biometric data 106 can include user gesture data (e.g., gait, how a user holds a phone, etc.), facial features (e.g., a photo of the user's face, a video of the user's face, etc.), voice features, fingerprint data, iris scan, retina scan, handprint, and/or other type of biometric data. In some examples, the biometric data is captured passively without user input. In other examples, the client device 103 prompts the user to provide the biometric data 106 via one or more user interactions.

In some examples, the wallet application 218 can generate the transaction payload 109 to include a verification token 226. The verification token 226 can be a security token issued to the client device 103 by an issuer servicer 209 and/or third-party verifier service to represent a verification of an identity of a user. In various examples, the verification token 226 can be generated in response to a determination to increase the security of the client device 103 based at least in part on a likelihood of fraud and a given user context. As such, the verification token 226 can be included in the transaction payload 109 for additional security and fraud prevention.

In some examples, the transaction payload 109 can be generated to be compliant with transfer standards of the direct wireless connection 115. For example, if the direct wireless connection 115 is a near-field communication (NFC) connection, the transaction payload 109 can be ISO7816 compliant and/or other NFC compliant tag that is generated to represent the credential to be transferred.

At block 309, the wallet application 218 via the communication device 245 can transmit the transaction payload 109 to the terminal 112. For example, the terminal 112 can act as a reader for the direct wireless connection 115 and is able to obtain the transaction payload 109 from the communication device 245 of the client device 103.

At block 312, the terminal service 248 of the terminal 112 can obtain biometric data 106 associated with the user. In some examples, the terminal service 248 obtains the biometric data 106 by extracting the captured biometric data 106 from the transaction payload 109 received from the client device 103. In other examples, the terminal service 248 can obtain biometric data 106 from a biometric capture device 251 included in or in data communication with the terminal 112. For example, the terminal service 248 can request that the biometric capture device 251 capture the biometric data 106 associated with a user of the client device 103.

At block 315, the terminal service 248 can generate an authorization request including the biometric data 106. The terminal 112 can generate an authorization request to send to the issuer associated with the credential of the transaction. The authorization request can include the captured biometric data 106 along with transaction data associated with the transaction. In some examples, the authorization request can include a verification token 226 that was included in the transaction payload 109.

At block 318, the terminal service 248 can send the authorization request to the issuer service 209. In various examples, the transaction payload 109 includes an issuer identifier associated with the credential presented for the given transaction. The terminal service 248 can use the issuer identifier to identify the credential issuer and transmit the authorization request over the network 206 to the issuer service 209 of the identified issuer.

At block 321, the issuer service 209 can analyze the transaction data and corresponding biometric data 106 included in the authorization request. For example, the issuer service 209 can analyze a variety of transaction authorization factors including the transaction data, the captured biometric data 106, user data 224, and/or other data to determine a risk associated with approving the transaction. In some examples, the issuer service 209 can assign weights to each of the transaction authorization factors. In this example, a score can be calculated based at least in part on a sum of the assigned weights and the issuer service 209 can authorize or deny the transaction based at least in part on whether the score meets or exceeds a predefined threshold value.

For example, using the pending transaction data included in an authorization request, the issuer service 209 can confirm that funds or credit is available for a given payment credential, such that the payment transaction is authorized to proceed or not authorized to proceed. In another example, the issuer service 209 can compare the captured biometric data 106 with the stored biometric data 221. If there is a match, the identity of the user can be verified according to the match.

In some examples, the issuer service 209 can execute the risk decision engine 212 to determine whether to authorize a given transaction. For example, the risk decision engine 212 can be executed to analyze one or more transaction authorization factors in determining whether to authorize or deny a transaction. The one or more transaction authorization factors can include, for example, the transaction data (e.g., transaction amount, merchant, transaction type, etc.), the captured biometric data 106, user data 224 (e.g., credential data 227, transaction history data 230, event data 233, behavior data 236, location data, date/time, etc.), and/or other data to determine a risk associated with approving the transaction. In some examples, the risk decision engine 212 can assign weights to each of the transaction authorization factors. In this example, a score can be calculated based at least in part on a sum of the assigned weights and the transaction can be authorized or denied based at least in part on a comparison of the score with a predefined threshold value. In other examples, the risk decision engine 212 can comprise a trained model that is trained to output a risk associated with the authorization of the pending transaction.

At block 324, the issuer service 209 can authorize the transaction. For example, if adequate funds are available and the captured biometric data 106 matches the stored biometric data 221, the issuer service 209 can determine that the transaction should be authorized. In some examples, the issuer service 209 can compare a risk score (e.g., calculated score, output of trained model, likelihood of risk, etc.) with one or more threshold values defined in the verification rules 242 to determine whether the transaction should be authorized or denied. For example, if the risk score is fails to meet or exceed a value that indicates a security risk, the issuer service 209 can authorize the transaction. Upon authorizing the transaction, the issuer service 209 can notify the terminal 121 that the transaction is authorized.

At block 327, the terminal service 248 can authorize the transaction. For example, the terminal service 248 can permit the transaction to continue and allow the user to obtain the result of the transaction. Thereafter, this portion of the process proceeds to completion.

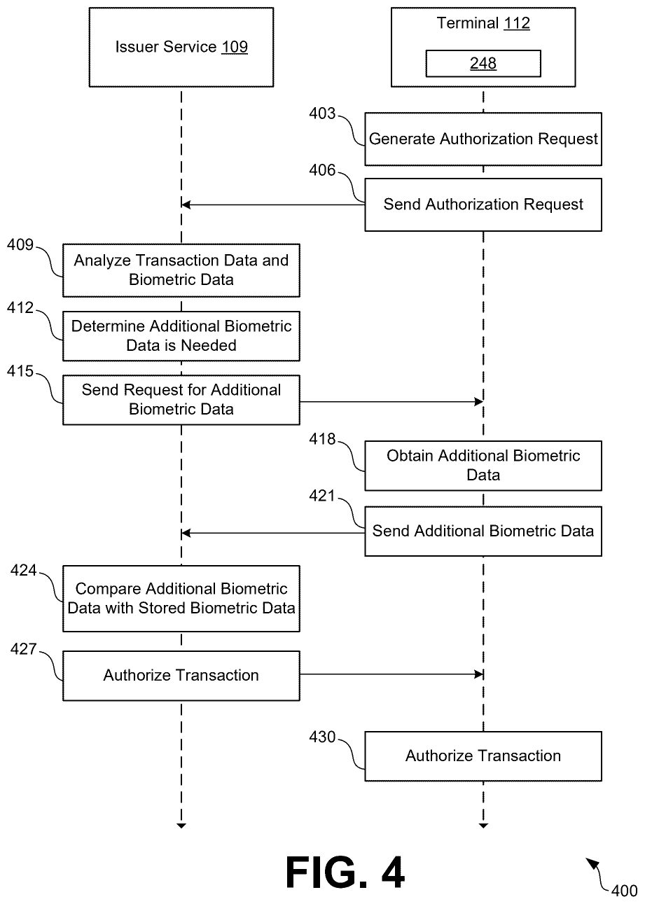

FIG. 4 illustrates a sequence diagram 400 that provides an example of the operation of the components of the network environment 200. It is understood that the sequence diagram 400 of FIG. 4 provides merely an example of the many different types of functional arrangements that can be employed to implement the operation of the depicted portion of the network environment 200. As an alternative, the sequence diagram 400 of FIG. 4 can be viewed as depicting an example of elements of a method implemented within the network environment 200.

To begin, at block 403, the terminal service 248 of the terminal 112 can generate an authorization request including the biometric data 106. The terminal 112 can generate an authorization request to send to the issuer associated with the credential of the transaction. The authorization request can include the captured biometric data 106 along with transaction data associated with the transaction. In some examples, the authorization request can include a verification token 226 that was included in the transaction payload 109.

At block 406, the terminal service 248 can send the authorization request to the issuer service 209. In various examples, the transaction payload 109 includes an issuer identifier associated with the credential presented for the given transaction. The terminal service 248 can use the issuer identifier to identify the credential issuer and transmit the authorization request over the network 206 to the issuer service 209 of the identified issuer.

At block 409, the issuer service 209 can analyze the transaction data and corresponding biometric data 106 included in the authorization request. For example, the issuer service 209 can analyze a variety of transaction authorization factors including the transaction data, the captured biometric data 106, user data 224, and/or other data to determine a risk associated with approving the transaction. In some examples, the issuer service 209 can assign weights to each of the transaction authorization factors. In this example, a score can be calculated based at least in part on a sum of the assigned weights and the issuer service 209 can authorize or deny the transaction based at least in part on whether the score meets or exceeds a predefined threshold value.

For example, using the pending transaction data included in an authorization request, the issuer service 209 can confirm that funds or credit is available for a given payment credential, such that the payment transaction is authorized to proceed or not authorized to proceed. In another example, the issuer service 209 can compare the captured biometric data 106 with the stored biometric data 221. If there is a match, the identity of the user can be verified according to the match.

In some examples, the issuer service 209 can execute the risk decision engine 212 to determine whether to authorize a given transaction. For example, the risk decision engine 212 can be executed to analyze one or more transaction authorization factors in determining whether to authorize or deny a transaction. The one or more transaction authorization factors can include, for example, the transaction data (e.g., transaction amount, merchant, transaction type, etc.), the captured biometric data 106, user data 224 (e.g., credential data 227, transaction history data 230, event data 233, behavior data 236, location data, date/time, etc.), and/or other data to determine a risk associated with approving the transaction. In some examples, the risk decision engine 212 can assign weights to each of the transaction authorization factors. In this example, a score can be calculated based at least in part on a sum of the assigned weights and the transaction can be authorized or denied based at least in part on a comparison of the score with a predefined threshold value. In other examples, the risk decision engine 212 can comprise a trained model that is trained to output a level of risk and/or risk score associated with the authorization of the pending transaction.

At block 412, the issuer service 209 can determine whether additional biometric data 106 is needed before authorizing the transaction. For example, if the captured biometric data 106 included in the authorization request fails to match the stored biometric data 106, the issuer service 209 can determine that additional biometric data 106 is required. In some examples, a calculated or otherwise determined risk score that is outputted from a risk decision engine 212 can indicate the likelihood of risk associated with the transaction. Based the risk score, the issuer service 209 can determine that additional captured biometric data 106 is needed from the user. For example, if the risk score is within a predefined range defined in the verification rules 242, the issuer service 209 can determine that the additional biometric data 106 is required.

At block 415, the issuer service 209 can send a request for additional biometric data to the terminal 112. For example, the issuer service 209 can generate a response to the authorization request that indicates that authorization requires the additional biometric data 106 to confirm that the user associated with the transaction is the user associated with the credential presented for the transaction.

At block 418, the terminal service 248 can obtain the additional biometric data 106. In some examples, the terminal service 248 can obtain the additional biometric data 106 from the client device 103 by requesting the client device 103 to capture and send the additional biometric data 106. In other examples, the terminal service 248 can obtain the additional biometric data 106 from a biometric capture device 251 included within or in data communication with the terminal 112.

At block 424, the terminal service 248 can send the additional biometric data 106 to the issuer service 209. For example, in response to the request for additional biometric data 106, the terminal service 248 can send the additional biometric data 106 to the issuer service 209 via the network 206.

At block 424, the issuer service 209 can compare the additional biometric data 106 with the stored biometric data 221 of the user account. For example, the issuer service 209 can compare one or more features associated with the additional biometric data 106 with the one or more features associated with the stored biometric data 221. In some examples, the issuer service 209 can generate a comparison score indicating a likelihood of a match. If the comparison score meets or exceeds a predefined threshold value, the issuer service 209 can determine that there is a match.

At block 427, the issuer service 209 can authorize the transaction. For example, if adequate funds are available and the additional biometric data 106 matches the stored biometric data 221, the issuer service 209 can determine that the transaction should be authorized. In some examples, the issuer service 209 can compare a risk score (e.g., calculated score, output of trained model, likelihood of risk, etc.) with one or more threshold values defined in the verification rules 242 to determine whether the transaction should be authorized or denied. For example, if the risk score is fails to meet or exceed a value that indicates a security risk, the issuer service 209 can authorize the transaction. Upon authorizing the transaction, the issuer service 209 can notify the terminal 121 that the transaction is authorized.

At block 430, the terminal service 248 can authorize the transaction. For example, the terminal service 248 can permit the transaction to continue and allow the user to obtain the result of the transaction. Thereafter, this portion of the process proceeds to completion.

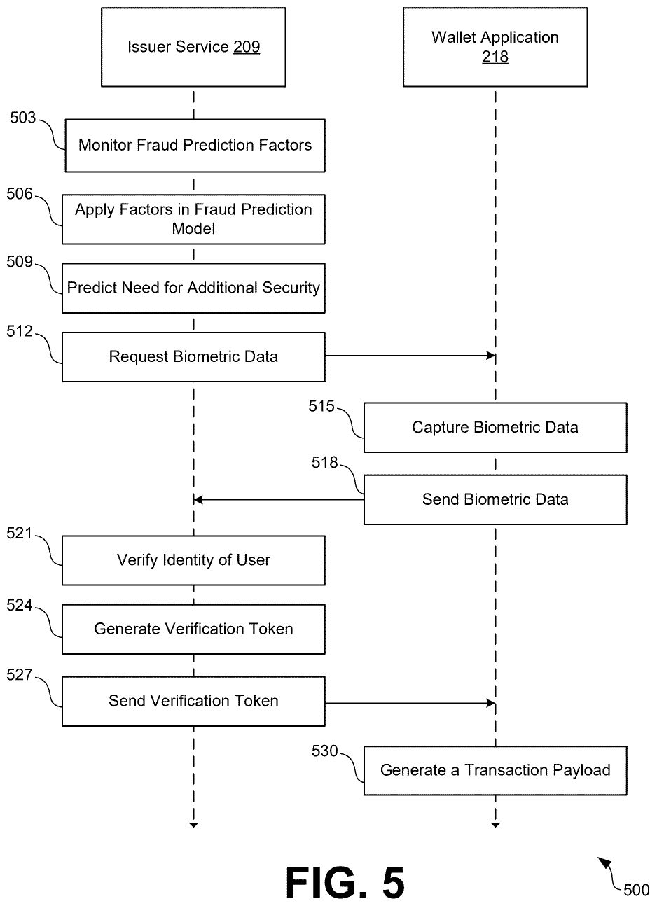

FIG. 5 illustrates a sequence diagram 500 that provides an example of the operation of the components of the network environment 200. It is understood that the sequence diagram 500 of FIG. 5 provides merely an example of the many different types of functional arrangements that can be employed to implement the operation of the depicted portion of the network environment 200. As an alternative, the sequence diagram 500 of FIG. 5 can be viewed as depicting an example of elements of a method implemented within the network environment 200.

At block 503, the issuer service 209 can monitor fraud prediction factors associated with a given user account. For example, the issuer service 209 can monitor fraud prediction factors associated with a given client device 103 and/or user account to determine whether an additional need for security is required for future or pending transactions. For example, the issuer service 209 can monitor fraud prediction factors including device location, a change in spend pattern, a user input, user behavior, a user gesture, a change in device language, user data 224 and/or other type of factors.

At block 506, the issuer service 209 can apply the fraud prediction factors to a fraud prediction model 225. According to various examples, the fraud prediction model 225 can be trained historical data to analyze input data (e.g., user data 224, device location, a change in spend pattern, a user input, user behavior 236, a user gesture, a change in device language, and/or other type of factor, etc.) to make an informed prediction of potential fraud with any future transactions.

At block 506, the issuer service 209 can predict a need for additional security with respect to the client device 103 and/or user account. In various examples, the output of the fraud prediction model 225 can include a value indicating a likelihood of fraud with respect to the context associated with the user account and/or client device 103 of the user of the user account. In some examples, if the value meets or exceeds a predefined threshold, the issuer service 209 can predict the need for additional security for the client device 103 and/or user account.

At block 509, the issuer service 209 can request biometric data 106 from the client device 103 associated with the user account. In some examples, the issuer service 209 can cause the wallet application 218 to generate and render a prompt or user interface 257 requesting the user to provide biometric data 106.

At block 512, the wallet application 218 can capture biometric data 106 associated with a user of the client device 103. For example, the wallet application 218 can interact with the biometric capture device 251 included within and/or in communication with the client device 103 to request the capture of biometric data 106. In various examples, the captured biometric data 106 can include user gesture data (e.g., gait, how a user holds a phone, etc.), facial features (e.g., a photo of the user's face, a video of the user's face, etc.), voice features, fingerprint data, iris scan, retina scan, handprint, and/or other type of biometric data associated with a user of the client device 103.

At block 515, the wallet application 218 can send the captured biometric data 106 to the issuer service 209. For example, in response to the request for biometric data, the wallet application 218 can send the captured biometric data 106 to the issuer service 209 via the network 206.

At block 518, the issuer service 209 can verify the identify of the user. For example, the issuer service 209 can compare the captured biometric data 106 with the stored biometric data 221 of the user account. For example, the issuer service 209 can compare one or more features associated with the additional biometric data 106 with the one or more features associated with the stored biometric data 221. In some examples, the issuer service 209 can generate a comparison score indicating a likelihood of a match. If the comparison score meets or exceeds a predefined threshold value, the issuer service 209 can determine that there is a match. In some examples, the issuer service 209 can send the captured biometric data 106 to a third-party verification service which compares the captured biometric data 106 to stored biometric data 221 associated with the user.

At block 521, the issuer service 209 can generate a verification token 226. The verification token 226 can correspond to a security token that is generated to represent the verification of the identity of the user. In various examples, the verification token 226 can be generated to include an expiration date such that the verification token 226 is valid for a predetermined amount of time. The issuer service 209 can then send the verification token 226 to the client device 103 at block 524.

At block 527, the wallet application 218 can generate a transaction payload 109 based at least in part on the transaction details and credential data 227 of a given credential. The transaction payload 109 can include a credential identifier, credential data 227, credential security features (e.g., public key), a digital signature, an expiration date, and/or other type of data that would be needed by a receiving terminal 112 to complete a transaction. In various examples, the wallet application 218 can generate the transaction payload 109 to include the verification token 226. Thereafter, this portion of the process proceeds to completion.

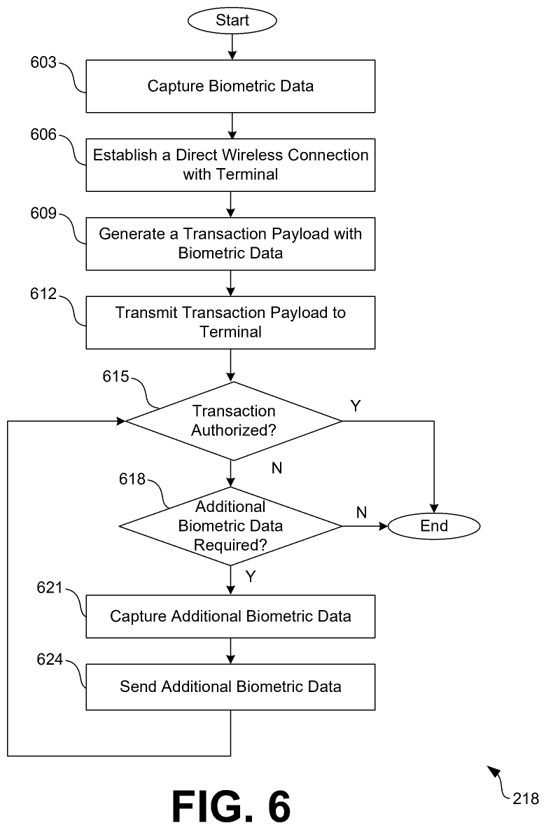

Referring next to FIG. 6, shown is a flowchart that provides one example of the operation of a portion of the wallet application 218. The flowchart of FIG. 6 provides merely an example of the many different types of functional arrangements that can be employed to implement the operation of the depicted portion of the wallet application 218. As an alternative, the flowchart of FIG. 6 can be viewed as depicting an example of elements of a method implemented within the network environment 200.

Beginning with block 603, the wallet application 218 can capture biometric data 106. For example, the wallet application 218 can interact with the biometric capture device 251 included within and/or in communication with the client device 103 to request the capture of biometric data 106. In various examples, the captured biometric data 106 can include user gesture data (e.g., gait, how a user holds a phone, etc.), facial features (e.g., a photo of the user's face, a video of the user's face, etc.), voice features, fingerprint data, iris scan, retina scan, handprint, and/or other type of biometric data associated with a user of the client device 103. In some examples, the biometric data is captured passively without user input. In other examples, the client device 103 prompts the user to provide the biometric data 106 via one or more user interactions through which the client device 103 can capture the biometric data 106 of the user.

At block 606, the wallet application 218 establishes a direct wireless connection 115 with a terminal 112. For example, when a user is wanting to complete a transaction, the user could tap or otherwise place the client device 103 and/or communication device 245 of the client device 103 in an appropriate proximity to the terminal 112 to establish a direct wireless connection 115 with the terminal 112. In some examples, once the direct wireless connection 115 is established with the terminal 112, the wallet application 218 can receive transaction details associated with the transaction such as, for example, a transaction amount, a terminal identifier, a merchant identifier, and/or other data.

At block 609, the wallet application 218 can generate a transaction payload 109 based at least in part on the captured biometric data 106, the transaction details, and credential data 227 of a given credential. The transaction payload 109 can include a credential identifier, credential data 227, credential security features (e.g., public key), a digital signature, an expiration date, and/or other type of data that would be needed by a receiving terminal 112 to complete a transaction. In some examples, the transaction payload 109 can be generated to be compliant with transfer standards of the direct wireless connection 115. For example, if the direct wireless connection 115 is a near-field communication (NFC) connection, the transaction payload 109 can be an ISO7816 compliant and/or other NFC compliant tag that is generated to represent the credential to be transferred.

At block 612, the wallet application 218 via the communication device 245 can transmit the transaction payload 109 to the terminal 112. For example, the terminal 112 can act as a reader for the direct wireless connection 115 and is able to obtain the transaction payload 109 from the communication device 245 of the client device 103.

At block 615, the wallet application 218 can determine if the transaction is authorized. For example, if the transaction is authorized, the terminal 112 may send a notification to the wallet application 218 that the transaction is authorized. Likewise, if the transaction has been denied, the terminal 112 may send a notification to the wallet application 218 that the transaction has been denied. In some examples, the terminal 112 can notify the user and the user can interact with a user interface 257 of the client device 103 to notify the wallet application 218 that the transaction has been authorized or denied. If the transaction has been authorized, this portion of the process proceeds to completion. If the transaction has been denied, the process proceeds to block 618.

At block 618, the wallet application 218 can determine if additional biometric data 106 is required. For example, the terminal 112 can notify the wallet application 218 if additional biometric data 106 is required if the issuer service 209 is unable to authorize the transaction. In some examples, the issuer service 209 can request the additional biometric data 106 from the client device 103 in response to receiving a transaction authorization request from a terminal 112. If additional biometric data 106 is required, the process proceeds to block 621. Otherwise, this portion of the process proceeds to completion.

At block 621, the wallet application 218 can capture additional biometric data 106. For example, the wallet application 218 can interact with the biometric capture device 251 included within and/or in communication with the client device 103 to request the capture of the additional biometric data 106. In various examples, the captured additional biometric data 106 can include user gesture data (e.g., gait, how a user holds a phone, etc.), facial features (e.g., a photo of the user's face, a video of the user's face, etc.) voice features, fingerprint data, iris scan, retina scan, handprint, and/or other type of biometric data associated with a user of the client device 103. In some examples, the additional biometric data is captured passively without user input. In other examples, the client device 103 can prompt the user to provide the additional biometric data 106 via one or more user interactions through the user interactions with the client device 103.

At block 624, the wallet application 218 can send the additional biometric data to the requesting entity. For example, if the terminal 112 has requested the additional biometric data 106 from the wallet application 218, the wallet application 218 can transmit the additional biometric data 106 to the terminal. If the issuer service 209 has requested the additional biometric data 106, the wallet application 218 can send the additional biometric data to the issuer service 209. Thereafter, the proceeds to block 615 to determine if the transaction has been authorized.

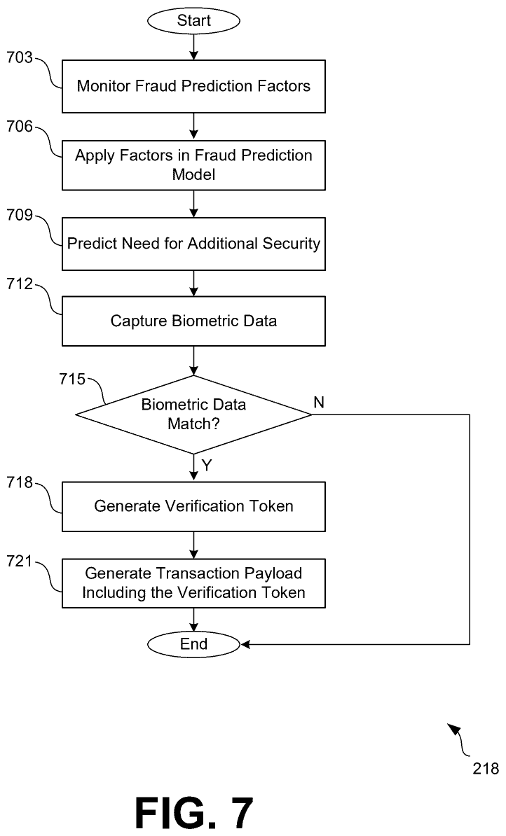

Referring next to FIG. 7, shown is a flowchart that provides one example of the operation of a portion of the wallet application 218. The flowchart of FIG. 7 provides merely an example of the many different types of functional arrangements that can be employed to implement the operation of the depicted portion of the wallet application 218. As an alternative, the flowchart of FIG. 7 can be viewed as depicting an example of elements of a method implemented within the network environment 200.

At block 703, the wallet application 218 can monitor fraud prediction factors associated with a given user account. For example, the wallet application 218 can monitor fraud prediction factors associated with a given client device 103 and/or user account to determine whether an additional need for security is required for future or pending transactions. For example, the wallet application 218 can monitor fraud predication factors including device location, a change in spend pattern, a user input, user behavior, a user gesture, a change in device language, user data 224 and/or other type of factors.

At block 706, the wallet application 218 can apply the fraud prediction factors to a fraud prediction model 225. According to various examples, the fraud prediction model 225 can be trained historical data to analyze input data (e.g., user data 224, device location, a change in spend pattern, a user input, user behavior 236, a user gesture, a change in device language, and/or other type of factor, etc.) to make an informed prediction of potential fraud with any future transactions.

At block 709, the wallet application 218 can predict a need for additional security with respect to the client device 103 and/or user account. In various examples, the output of the fraud prediction model 225 can include a value indicating a likelihood of fraud with respect to the context associated with the user account and/or client device 103 of the user of the user account. In some examples, if the value meets or exceeds a predefined threshold, the wallet application 218 can predict the need for additional security for the client device 103 and/or user account.

At block 712, the wallet application 218 can capture biometric data 106 associated with a user of the client device 103. For example, the wallet application 218 can interact with the biometric capture device 251 included within and/or in communication with the client device 103 to request the capture of biometric data 106. In various examples, the captured biometric data 106 can include user gesture data (e.g., gait, how a user holds a phone, etc.), facial features (e.g., a photo of the user's face, a video of the user's face, etc.) voice features, fingerprint data, iris scan, retina scan, handprint, and/or other type of biometric data associated with a user of the client device 103.

At block 715, the wallet application 218 can determine if the captured biometric data 106 matches stored biometric data 221 that is stored in the client device 103. For example, the wallet application 218 can compare one or more features associated with the captured biometric data 106 with the one or more features associated with the stored biometric data 221. In some examples, the wallet application 218 can generate a comparison score indicating a likelihood of a match. If the comparison score meets or exceeds a predefined threshold value, the wallet application 218 can determine that there is a match. In some examples, the wallet application 218 can send the captured biometric data 106 to a third-party verification service which compares the captured biometric data 106 to stored biometric data 221 associated with the user. If there is not a match, the process proceeds to completion. If there is a match, the process proceeds to block 718.

At block 718, the wallet application 218 can generate a verification token 226. The verification token 226 can correspond to a security token that is generated to represent the verification of the identity of the user. In various examples, the verification token 226 can be generated to include an expiration date such that the verification token 226 is valid for a predetermined amount of time.

At block 721, the wallet application 218 can generate a transaction payload 109 based at least in part on the transaction details and credential data 227 of a given credential. The transaction payload 109 can include a credential identifier, credential data 227, credential security features (e.g., public key), a digital signature, an expiration date, and/or other type of data that would be needed by a receiving terminal 112 to complete a transaction. In various examples, the wallet application 218 can generate the transaction payload 109 to include the verification token 226. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
receive an authorization request from a terminal device to authorize a transaction, the authorization request being associated with a user account and including biometric data of a user;
compare the biometric data with stored biometric data associated with the user account in response to receiving the authorization request; and
authorize the transaction based at least in part on comparing the biometric data with the stored biometric data and an analysis of the authorization request.

2. The system of claim 1, wherein the machine-readable instructions further cause the computing device to at least:
determine that additional biometric data is required in response to comparing the biometric data with the stored biometric data;
send a request for the additional biometric data to a client device associated with the user or the terminal; and
receive the additional biometric data, the transaction being authorized in response to the additional biometric data matching the stored biometric data.

3. The system of claim 1, wherein the machine-readable instructions further cause the computing device to at least:
predict a need for additional security for future transactions associated with the user account; and
verify an identify of the user in response to the need for additional security being predicted.

4. The system of claim 3, wherein the need for additional security is predicted based at least in part on one or more factors comprising at least one of: a change in device location, a change in spend patterns, a user input, a user behavior; a user gesture, or a device language.

5. The system of claim 4, wherein the machine-readable instructions further cause the computing device to at least:
apply the one or more factors to a fraud prediction model; and
the need for additional security for future transactions being predicted based at least in part on an output of the fraud prediction model.

6. The system of claim 3, wherein the machine-readable instructions further cause the computing device to at least:
generate a verification token in response to verifying the identity of the user; and
transmit the verification token to a client device, the authorization request comprising the verification token.

7. The system of claim 1, wherein the machine-readable instructions further cause the computing device to at least:
collect transaction data associated with the authorization request, the transaction data including the biometric data; and
apply the transaction data to a risk decision engine, the transaction being authorized based at least in part on an output of the risk decision engine.

8. A method, comprising:
capturing biometric data corresponding to a user associated with a user account;
generating a transaction tag including transaction data associated with a transaction and the user account;
establishing a direct wireless connection with a terminal; and
transferring the transaction tag to the terminal, the transaction being authorized by an issuer in response to a verification of the biometric data verified by the verifying computing device, the biometric data being included in the transaction tag or being verified prior to the transaction.

9. The method of claim 8, further comprising:
receiving a request for additional biometric data from the terminal;
capturing the additional biometric data from the user; and
sending the additional biometric data to the terminal via the direct wireless connection, the transaction being authorized further in response to the additional biometric data.

10. The method of claim 8, further comprising receiving a user request identifying additional security for transactions associated with the user account, the user request including context factors associated with a need for additional security, the biometric data being captured in response to receiving the user request.

11. The method of claim 8, further comprising:
sending the biometric data to a verifying device; and
receiving a verification token from the verifying device, the transaction tag being generated to include the verification token.

12. The method of claim 8, further comprising generating the transaction tag to include the biometric data.

13. The method of claim 8, wherein the transaction data includes at least one of a user account identifier, an expiration data, a terminal identifier, a merchant identifier, a transaction amount, a user address, a card verification code, or an issuer name.

14. The method of claim 8, further comprising:
comparing the biometric data with stored biometric data to verify the biometric data;
generating a verification token in response to the biometric data matching the stored biometric data; and
generating the transaction tag to include the verification token.

15. A non-transitory, computer-readable medium, comprising machine-readable instructions that, when executed by a processor of a computing device, cause the computing device to at least:
establish a direct wireless connection with a client device associated with a user;
receive a transaction tag from the client device via the direct wireless connection, the transaction tag including transaction data associated with a transaction between the user and a merchant;
generate an authorization request comprising the transaction data and biometric data associated with the user;
send the authorization request to an issuer computing device associated with the client device; and
authorize the transaction based at least in part on a response to the authorization request from the issuer computing device.

16. The non-transitory, computer-readable medium of claim 15, wherein the biometric data is included in the transaction tag, and the machine-readable instructions, when executed by the processor, further cause the computing device to at least extract the biometric data from the transaction tag.

17. The non-transitory, computer-readable medium of claim 15, wherein the machine-readable instructions, when executed by the processor, further cause the computing device to at least:
capture the biometric data of the user via a camera in data communication with the computing device.

18. The non-transitory, computer-readable medium of claim 15, wherein the machine-readable instructions, when executed by the processor, further cause the computing device to at least:
receive a request from the issuer computing device for additional biometric data associated with the user; and
transmit the additional biometric data to the issuer computing device, the transaction being authorized based at least in part on receiving a verification from the issuer computing device indicating that the additional biometric data matches stored biometric data.

19. The non-transitory, computer-readable medium of claim 18, wherein the machine-readable instructions, when executed by the processor, further cause the computing device to at least:
prompt the user for the additional biometric data; and
receive the additional biometric data via the direct wireless connection.

20. The non-transitory, computer-readable medium of claim 15, wherein the transaction tag comprises a verification token, and the machine-readable instructions, when executed by the processor, further cause the computing device to at least verify the verification token included in the transaction tag, the authorization request including an indication that an identify of the user has been verified.
